(19) United States
(12) Patent Application Publication
(10) Pub. No.: US 2026/0298399 A1
(43) Pub. Date: Oct. 1, 2026

(54) DECORATION

(71) Applicant: JIEH-CHUNG CHEN, TAINAN CITY (TW)

(72) Inventor: JIEH-CHUNG CHEN, TAINAN CITY (TW)

(21) Appl. No.: 19/440,673

(22) Filed: Jan. 6, 2026

Related U.S. Application Data
(63) Continuation-in-part of application No. 19/096,621, filed on Mar. 31, 2025.

(51) Int. Cl. F16M 11/08; A47G 33/12; A63H 33/28; F16M 11/22

(52) U.S. Cl. CPC F16M 11/08; A63H 33/28; F16M 11/22; A47G 33/126

(57) ABSTRACT

A decoration includes a multifunctional support mechanism and a decorative structure. The multifunctional support mechanism includes a carrying assembly having a carrier cavity, a fixing assembly disposed in the carrier cavity, an atomization assembly disposed in the carrier cavity, and a control member. A fixing end of the fixing assembly is in spatial communication with an external environment. An atomization end of the atomization assembly is in spatial communication with the external environment. The control member is electrically connected to the atomization assembly. The fixing assembly, the atomization assembly, and the control member are disposed in the carrier cavity, an external component is connected to the fixing assembly, the atomization assembly atomizes a corresponding liquid to form a mist and discharges the mist to the external environment, and the control member controls operation of the atomization assembly. The decorative structure is sleeved on the connecting member.

### CROSS-REFERENCE TO RELATED PATENT APPLICATION

This application is a Continuation-In-Part of the U.S. application Ser. No. 19/096,621, filed on Mar. 31, 2025 and entitled “MULTIFUNCTIONAL SUPPORT MECHANISM”, now pending.

### FIELD OF THE DISCLOSURE

The present disclosure relates to a craft decoration, and more particularly to a decoration having an atomization effect.

### BACKGROUND OF THE DISCLOSURE

Christmas is the most celebrated holiday in Europe and America, and setting up a Christmas tree is an important custom of this festival. In the past, people would place evergreen plants (such as pine trees) indoors and outdoors during the Christmas season, and decorate these evergreen plants with Christmas lights and colorful ornaments. However, since use of traditional Christmas trees results in a large consumption of forest resources and is not conducive to environmental protection, artificial Christmas trees are gradually gaining popularity. The artificial Christmas tree is formed by three parts, which include a trunk, branches, and a base. Currently, the base that is commonly available on the market only provides a single supporting function.

### SUMMARY OF THE DISCLOSURE

In response to the above-referenced technical inadequacy, the present disclosure provides a decoration.

In order to solve the above-mentioned problem, one of the technical aspects adopted by the present disclosure is to provide a decoration. The decoration includes a multifunctional support mechanism and a decorative structure. The multifunctional support mechanism includes a carrying assembly, a fixing assembly, an atomization assembly, and a control member. The carrying assembly has a carrier cavity. The fixing assembly is disposed in the carrier cavity, and a fixing end of the fixing assembly is in spatial communication with an external environment. The fixing assembly includes a fixing member, a connecting member, and an engaging member, the fixing member is disposed in the carrier cavity, the connecting member is movably disposed in the fixing member, the engaging member is rotatably connected to the fixing member, and the engaging member abuts against the connecting member. The atomization assembly is disposed in the carrier cavity, and an atomization end of the atomization assembly is in spatial communication with the external environment. The control member is disposed in the carrier cavity, and is electrically connected to the atomization assembly. The decorative structure is sleeved on the connecting member.

In one of the possible or preferred embodiments, the carrying assembly includes a carrier member, a first shielding member, and a second shielding member, the first shielding member and the second shielding member are detachably disposed in the carrier member, and the carrier cavity is jointly formed by the carrier member, the first shielding member, and the second shielding member.

In one of the possible or preferred embodiments, the carrier member has a carrier slot, a first carrier flange, and a plurality of first limiting blocks, the first carrier flange is disposed around an inner wall of the carrier slot, the plurality of first limiting blocks are spaced apart from each other and disposed around the inner wall of the carrier slot, a gap is defined between the first carrier flange and the plurality of first limiting blocks, the first shielding member and the second shielding member are located in the gap, and the carrier cavity is jointly formed by the carrier slot, the first shielding member, and the second shielding member.

In one of the possible or preferred embodiments, the first shielding member has a through hole and a buckle, the atomization end of the atomization assembly is in spatial communication with the through hole, and the buckle movably abuts against the first limiting blocks.

In one of the possible or preferred embodiments, the fixing member has an installation slot and a buckling notch that is in spatial communication with the installation slot, the connecting member is movably disposed in the installation slot, and the engaging member abuts against a retaining groove of the connecting member through the buckling notch.

In one of the possible or preferred embodiments, the engaging member includes a pressing plate, a cantilever arranged on the pressing plate, and a buckling block that is arranged on the pressing plate, the pressing plate is rotatably connected to the fixing member through the cantilever, and the buckling block abuts against the retaining groove of the connecting member through the buckling notch. The fixing assembly further includes a first elastic member, and two ends of the first elastic member are respectively connected to the fixing member and the pressing plate.

In one of the possible or preferred embodiments, the atomization assembly includes a mounting member, a blower disposed in the mounting member, and an atomizer that is disposed in the mounting member, the mounting member has a mist outlet, an atomization end of the atomizer is in spatial communication with the mist outlet, and the atomizer is electrically connected to the control member.

In one of the possible or preferred embodiments, the atomizer includes a first support tube, a support frame, a guide tube, a second support tube, a second elastic member, a water-absorbing body, an atomizing sheet, and a sensor. The first support tube, the guide tube, and the second support tube are in spatial communication with each other, the support frame is disposed in the first support tube, the support frame has a first orifice, the second elastic member is disposed in the second support tube, the water-absorbing body is connected to the second elastic member, the atomizing sheet abuts against the water-absorbing body, the atomizing sheet discharges mist outward from the second support tube, and a sensing end of the sensor is located in the first support tube, the guide tube or the second support tube.

In one of the possible or preferred embodiments, the support frame has a top block, the top block protrudes from the support frame, an outer edge of the top block has a second orifice, and the second orifice and the first orifice are in spatial communication with the guide tube.

In one of the possible or preferred embodiments, the decorative structure includes a decorative body and a docking member disposed on one side of the decorative body, and the decorative structure is detachably disposed on the connecting member through the docking member.

In one of the possible or preferred embodiments, the docking member includes a first connecting portion connected to the decorative body, a second connecting portion disposed on one side of the first connecting portion and detachably disposed on the connecting member, and an adjusting portion connected to the second connecting portion. The first connecting portion is movable in a direction away from the second connecting portion along the adjusting portion to enable the decorative body to move in a direction away from the multifunctional support mechanism.

In one of the possible or preferred embodiments, the decorative structure further includes a plurality of light strips disposed on the decorative body, and the plurality of light strips are configured to emit light.

In one of the possible or preferred embodiments, one side of the connecting member has a buckle formed thereon, the docking member has a docking portion disposed on the second connecting portion, and the docking portion corresponds in shape to the buckle. the docking portion is sleeved on the buckle to enable the decorative structure to fix to the multifunctional support mechanism.

In one of the possible or preferred embodiments, the connecting member has an external thread, and the docking member has an internal thread that is threadedly engaged with the external thread.

In order to solve the above-mentioned problem, another one of the technical aspects adopted by the present disclosure is to provide a decoration. The decoration includes a multifunctional support mechanism and a decorative structure. The multifunctional support mechanism includes a carrying assembly having a carrier cavity, a fixing assembly disposed in the carrier cavity, an atomization assembly disposed in the carrier cavity, and a control member disposed in the carrier cavity. The carrying assembly includes a carrier member, a first shielding member, a second shielding member, and an extension member, and the extension member is formed by extending from the carrier member in a direction away from the first shielding member and the second shielding member. The first shielding member and the second shielding member are detachably disposed in the carrier member, and the carrier cavity is jointly formed by the carrier member, the first shielding member, and the second shielding member. The extension member, the first shielding member, and the second shielding member jointly define an accommodating cavity. A fixing end of the fixing assembly is in spatial communication with an external environment. The fixing assembly includes a fixing member, a connecting member, and an engaging member, the fixing member is disposed in the carrier cavity, the connecting member is movably disposed in the fixing member, the engaging member is rotatably connected to the fixing member, and the engaging member abuts against the connecting member. An atomization end of the atomization assembly is in spatial communication with the external environment. The control member is electrically connected to the atomization assembly. The decorative structure is disposed on the extension member, and one part of the decorative structure is arranged in the accommodating cavity.

Therefore, in the decoration provided by the present disclosure, through a configuration between the decorative structure and the multifunctional support mechanism, an overall aesthetic of an environment (e.g., an indoor environment or an outdoor environment) can be effectively enhanced. Moreover, the fixing assembly, the atomization assembly, and the control member are disposed in the carrier cavity, an external component is connected to the fixing assembly, the atomization assembly atomizes a corresponding liquid to form the mist and discharges the mist to the external environment, and the control member controls operation of the atomization assembly, so that not only can the external component of various types be replaced, but an atomization effect can also be generated by the atomization assembly. Accordingly, the multifunctional support mechanism not only provides a supporting function, but also has an atomization function.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective view of a multifunctional support mechanism according to a first embodiment of the present disclosure;

FIG. 2 is a schematic perspective view showing the multifunctional support mechanism from another viewing angle according to the first embodiment of the present disclosure;

FIG. 3 is a schematic enlarged view of part A of FIG. 2;

FIG. 4 is a schematic perspective view of a fixing assembly according to the first embodiment of the present disclosure;

FIG. 5 is a schematic exploded view of the fixing assembly according to the first embodiment of the present disclosure;

FIG. 6 is a schematic perspective view of an atomization assembly according to the first embodiment of the present disclosure;

FIG. 7 is a schematic cross-sectional view of the atomization assembly according to the first embodiment of the present disclosure;

FIG. 8 is a schematic perspective view showing the atomization assembly from another viewing angle according to the first embodiment of the present disclosure;

FIG. 9 is a schematic perspective view of a decoration according to a second embodiment of the present disclosure;

FIG. 10 is a schematic exploded view of FIG. 9;

FIG. 11 is a schematic perspective view of another type of the decoration of FIG. 9;

FIG. 12 is a schematic perspective view of another type of a decorative structure of FIG. 9;

FIG. 13 is a schematic exploded view of FIG. 12;

FIG. 14 is a schematic perspective view of a decoration according to a third embodiment of the present disclosure; and

FIG. 15 is a schematic exploded view of FIG. 14.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

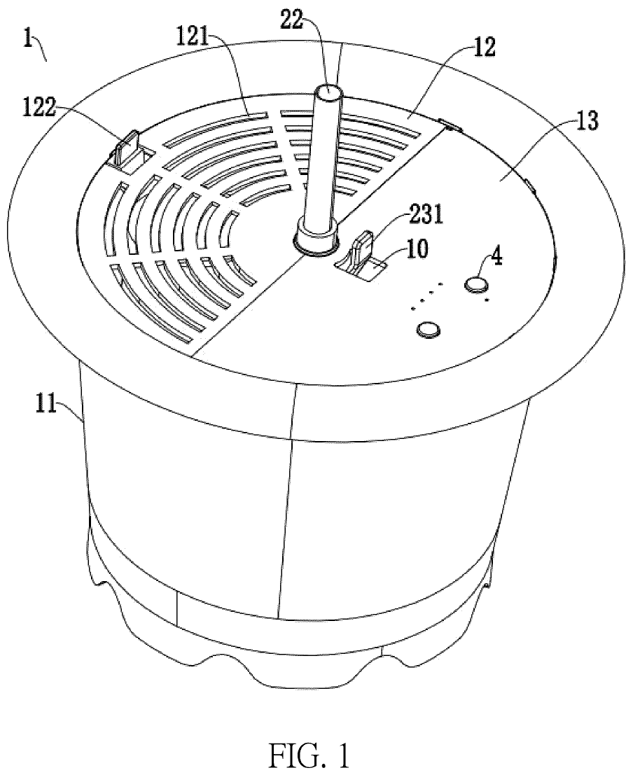

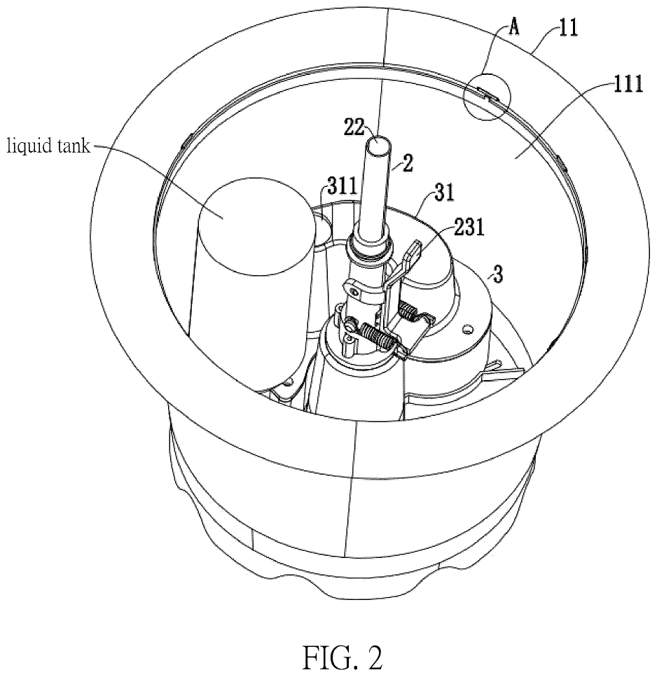

Referring to FIG. 1 and FIG. 2, FIG. 1 is a schematic perspective view of a multifunctional support mechanism, and FIG. 2 is a schematic perspective view showing the multifunctional support mechanism from another viewing angle. The multifunctional support mechanism of the present embodiment includes a carrying assembly 1, a fixing assembly 2, an atomization assembly 3, and a control member 4. The carrying assembly 1 is configured to carry the fixing assembly 2, the fixing assembly 2, and the control member 4. The fixing assembly 2 has a fixing end. The fixing end is in spatial communication with an external environment of the carrying assembly 1, so as to be conveniently fixed to an external component. The external component can be a Christmas tree or other components. The atomization assembly 3 has an atomization end. The atomization end is in spatial communication with the external environment of the carrying assembly 1, so as to generate and discharge a mist to the external environment. The control member 4 is electrically connected to the atomization assembly 3, so as to control operation of the atomizing assembly 3 to be turned on or off and control a working time and a working mode of the atomizing assembly 3.

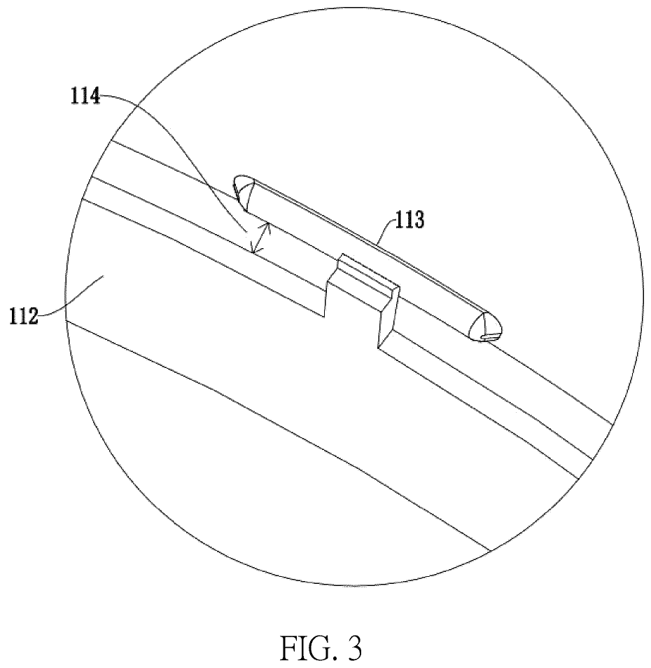

Referring to FIG. 3, FIG. 3 is a schematic enlarged view of part A of FIG. 2. The carrying assembly 1 includes a carrier member 11, a first shielding member 12, and a second shielding member 13. The carrier member 11 has a carrier slot 111, and the first shielding member 12 and the second shielding member 13 are both detachably disposed in a notch of the carrier slot 111. After the carrier member 11, the first shielding member 12, and the second shielding member 13 are assembled, an interior of the carrier member 11, the first shielding member 12, and the second shielding member 13 is formed into a carrier cavity 10, and the fixing assembly 2, the atomization assembly 3, and the control member 4 are disposed in the carrier cavity 10. In practice, the carrier member 11 further has a first carrier flange 112 and a plurality of first limiting blocks 113, the first carrier flange 112 is disposed on a wall surface of the carrier slot 111, and the first limiting blocks 113 are also disposed on the wall surface of the carrier slot 111. A gap 114 is defined between the first carrier flange 112 and the plurality of first limiting blocks 113, and the first shielding member 12 and the second shielding member 13 are located in the gap 114. More specifically, the first carrier flange 112 is disposed around the wall surface of the carrier slot 111, a quantity of the first limiting blocks 113 is more than one, the plurality of first limiting blocks 113 are spaced apart from each other and disposed around the wall surface of the carrier slot 111, and the first limiting blocks 113 are located above the first carrier flange 112. The first carrier flange 112 and the first limiting blocks 113 are cooperatively arranged to limit the first shielding member 12 and the second shielding member 13, thereby preventing the first shielding member 12 and the second shielding member 13 from being easily detached from the carrier member 11. It should be noted that, although the first limiting blocks 113 limits the first shielding member 12 and the second shielding member 13, the first shielding member 12 and the second shielding member 13 can be inserted or removed by exertion of a certain amount of force.

Furthermore, the first shielding member 12 has a through hole 121 and a buckle 122, and the through hole 121 is in spatial communication with the atomization end of the atomization assembly 3, so as to discharge the mist generated by the atomization assembly 3 to the external environment. The buckle 122 is arranged on an edge of the first shielding member 12, and one end of the buckle 122 protrudes into the external environment. The buckle 122 corresponds in position to and abuts against one of the first limiting blocks 113, and the buckle 122 is movable relative to the first shielding member 12. When the first shielding member 12 needs to be removed from the carrier member 11, the position of the buckle 122 is adjusted, so that the buckle 122 is no longer in contact with the first limiting blocks 113, and the first shielding member 12 can be drawn out. More specifically, the buckle 122 is made of a plastic material and can be deformed under a certain external force, and a deformation process is equivalent to relative movement between the buckle 122 and the first limiting blocks 113. In the present embodiment, a quantity of the through hole 121 is more than one, and the shape of the through hole 121 is elongated and arc-shaped, thereby not only enhancing a range of the discharged mist but also improving an aesthetic appearance.

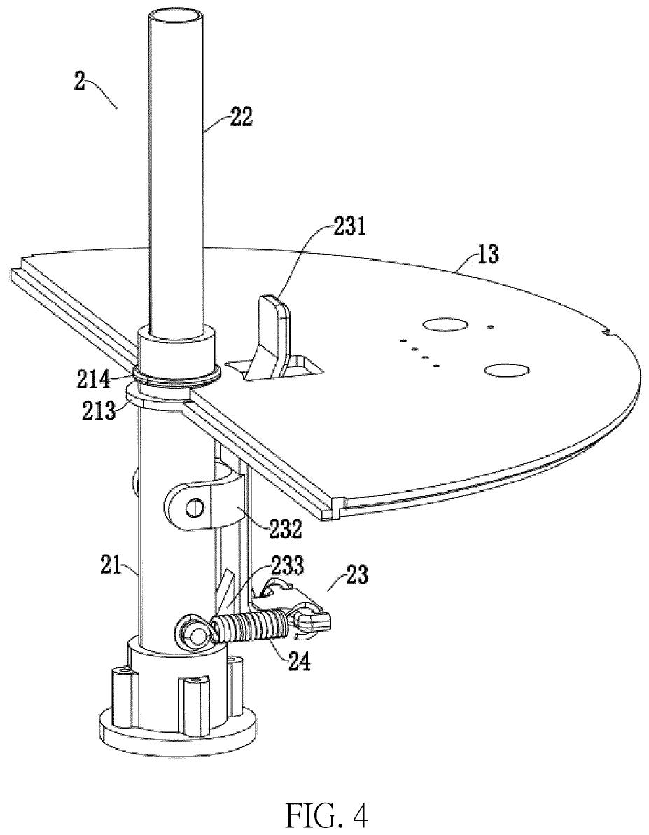

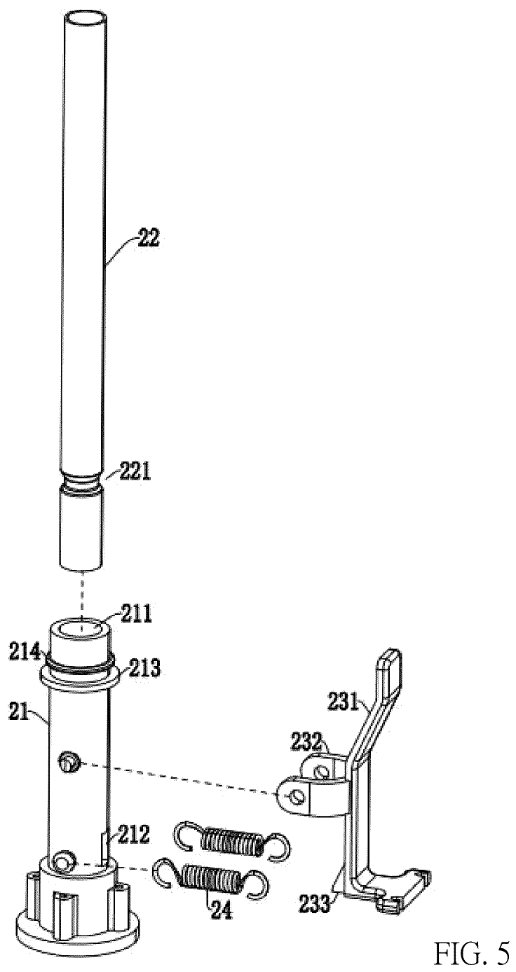

Referring to FIG. 4 and FIG. 5, FIG. 4 is a schematic perspective view of the fixing assembly 2, and FIG. 5 is a schematic exploded view of the fixing assembly 2. The fixing assembly 2 includes a fixing member 21, a connecting member 22, and an engaging member 23. The fixing member 21 is disposed in the carrier slot 111 of the carrier member 11, the connecting member 22 is detachably disposed in the fixing member 21, one end of the connecting member 22 extends to the external environment and is formed into the fixing end, and the external component is detachably connected to the connecting member 22. The engaging member 23 is rotatably disposed on the fixing member 21, and the engaging member 23 abuts against the connecting member 22, such that the connecting member 22 can be fixed through the engaging member 23. In practice, the fixing member 21 has an installation slot 211 and a buckling notch 212 that is in spatial communication with the installation slot 211, the connecting member 22 is disposed in the installation slot 211, and the engaging member 23 abuts against the connecting member 22 through the buckling notch 212.

The engaging member 23 includes a pressing plate 231, a cantilever 232, and a buckling block 233. One end of the pressing plate 231 extends to the external environment by passing through the second shielding member 13, the cantilever 232 is rotatably connected to an outer wall of the fixing member 21, the pressing plate 231 is connected to the cantilever 232, and the buckling block 233 is arranged on another end of the pressing plate 231. Therefore, the buckling block 233 extends into the installation slot 211 through the buckling notch 212, and abuts against the connecting member 22. More specifically, the connecting member 22 has a retaining groove 221. When the connecting member 22 is installed in place or the retaining groove 221 is located at the buckling notch 212, the buckling block 233 is inserted into the retaining groove 221 to fix the connecting member 22. Similarly, when the connecting member 22 needs to be removed, force needs to be applied to one end of the pressing plate 231 that extends to the external environment, so that the buckling block 233 is detached from the retaining groove 221.

Furthermore, the fixing assembly 2 further includes a first elastic member 24. One end of the first elastic member 24 is connected to the fixing member 21, and another end of the first elastic member 24 is connected to the pressing plate 231. When the external force is removed from the pressing plate 231, the pressing plate 231 is reset through the first elastic member 24. More specifically, the first elastic member 24 is a spring, a quantity of the first elastic member 24 is two, and the two first elastic members 24 are respectively located at both sides of the fixing member 21. When the external force is applied to one end of the pressing plate 231, the first elastic member 24 is in a stretched state. After the external force is removed, the pressing plate 231 is reset due to an elastic force of the first elastic member 24.

As shown in FIG. 4 and FIG. 5, the fixing member 21 further has a second carrier flange 213 and a second limiting block 214. The second carrier flange 213 and the second limiting block 214 are disposed around an external surface of the fixing member 21, and the second carrier flange 213 is spaced apart from the second limiting block 214. In use, a portion of an outer edge of the first shielding member 12 is located in the gap 114 of the carrier member 11, and a portion of an edge of the first shielding member 12 is located between the second carrier flange 213 and the second limiting block 214, so as to improve load-bearing stability of the first shielding member 12. Similarly, the second shielding member 13 and the first shielding member 12 are in the same situation, and will not be reiterated herein.

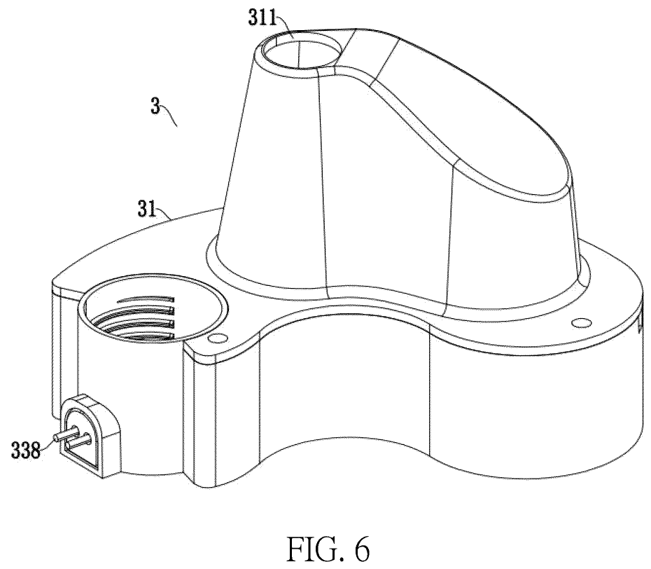

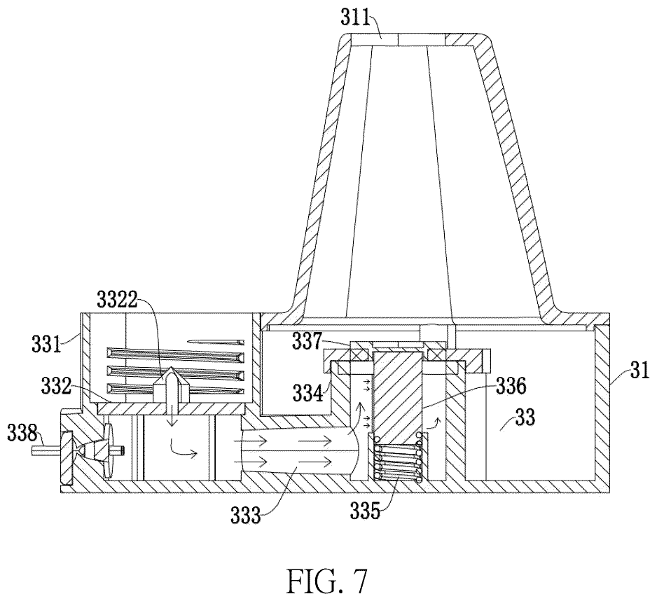

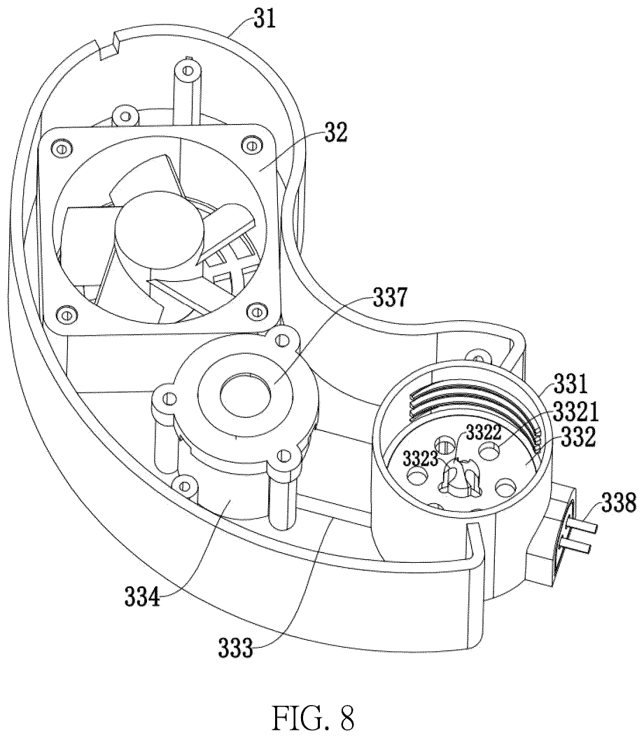

Referring to FIG. 6 to FIG. 8, FIG. 6 is a schematic perspective view of the atomization assembly 3, FIG. 7 is a schematic cross-sectional view of the atomization assembly 3, and FIG. 8 is a schematic perspective view showing the atomization assembly 3 from another viewing angle. The atomization assembly 3 includes a mounting member 31, a blower 32, and an atomizer 33. The mounting member 31 is disposed in the carrier slot 111, the blower 32 and the atomizer 33 are disposed in the mounting member 31, the mounting member 31 has a mist outlet 311, the atomizer 33 has an atomization end, and the atomization end, the mist outlet 311, and the through hole 121 are in spatial communication with each other. In use, the atomization end of the atomizer 33 outputs the mist, and the mist is discharged to the through hole 121 through the mist outlet 311 due to actuation of the blower 32. Then, the mist is discharged to the external environment through the through hole 121. More specifically, the blower 32 can be independently operated with a power supply, or operation of the blower 32 can be controlled by the control member 4 when the blower 32 is electrically connected to the control member 4.

In practice, the atomizer 33 includes a first support tube 331, a support frame 332, a guide tube 333, a second support tube 334, a second elastic member 335, a water-absorbing body 336, an atomizing sheet 337, and a sensor 338. The first support tube 331, the guide tube 333, and the second support tube 334 are in spatial communication with each other, the support frame 332 is disposed in the first support tube 331, the second elastic member 335 is disposed in the second support tube 334, and the water-absorbing body 336 is connected to an end of the second elastic member 335. The atomizing sheet 337 is disposed on the second support tube 334, the atomizing sheet 337 abuts against the water-absorbing body 336, the sensor 338 has a sensing end that is located in the first support tube 331, the guide tube 333, or the second support tube 334, and the atomizing sheet 337 and the sensor 338 are electrically connected to the control member 4. Furthermore, the support frame 332 has a plurality of first orifices 3321, the plurality of first orifices 3321 are spaced apart from each other and distributed on the support frame 332, and the first orifices 3321 are in spatial communication with the guide tube 333. More specifically, the support frame 332 further has a top block 3322, the top block 3322 protrudes from a surface of the support frame 332, a surface of the top block 3322 has a second orifice 3323, and the second orifice 3323 is in spatial communication with the guide tube 333.

In present embodiment, the blower 32 is a fan, the second elastic member 335 is a spring, the water-absorbing body 336 is a sponge, the atomizing sheet 337 is an existing atomizing product, and the sensor 338 is an existing detection product used to detect whether or not there is a liquid.

In use, a liquid tank is first inserted into the first support tube 331. The liquid in the liquid tank flows into the guide tube 333 through the first orifices 3321 and the second orifice 3323 of the top block 3322, and then flows from the guide tube 333 to the second support tube 334. Then, the liquid is in contact with and absorbed by the water-absorbing body 336. The liquid absorbed by the water-absorbing body 336 is transported to the atomizing sheet 337, and the atomizing sheet 337 generates the mist. Due to actuation of the second elastic member 335, the water-absorbing body 336 continues to abut against the atomizing sheet 337 and transport the liquid to the atomizing sheet 337. Due to actuation of the blower 32, the mist generated by the atomizing sheet 337 is sequentially discharged through the mist outlet 311 and the through hole 121, and is finally discharged to the external environment. In the above process, the sensor 338 continues to detect the liquid, and transmits information to the control member 4.

More specifically, the control member 4 adopts an existing control system, which can control the atomizing sheet 337, the blower 32, and the sensor 338. In addition, through lights (e.g., a green light for a start state and a red light for a stop state), the control member 4 can also display a corresponding status. Furthermore, a button can be added to a surface of the second shielding member 13, so as to start working or adjust a working mode of the atomizing sheet 337 (e.g., a time setting button, a button for one hour of working time, or a button for two hours of working time). The above functions can be realized by circuit boards and chips in the related art.

### Second Embodiment

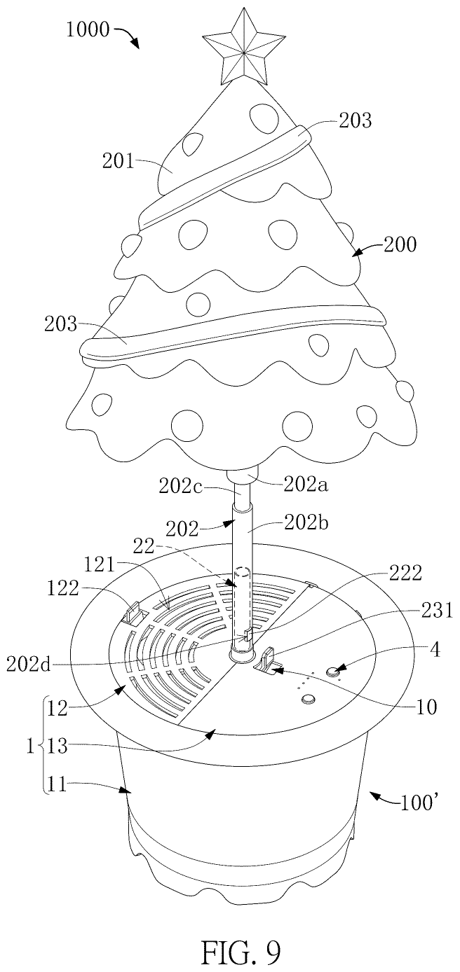

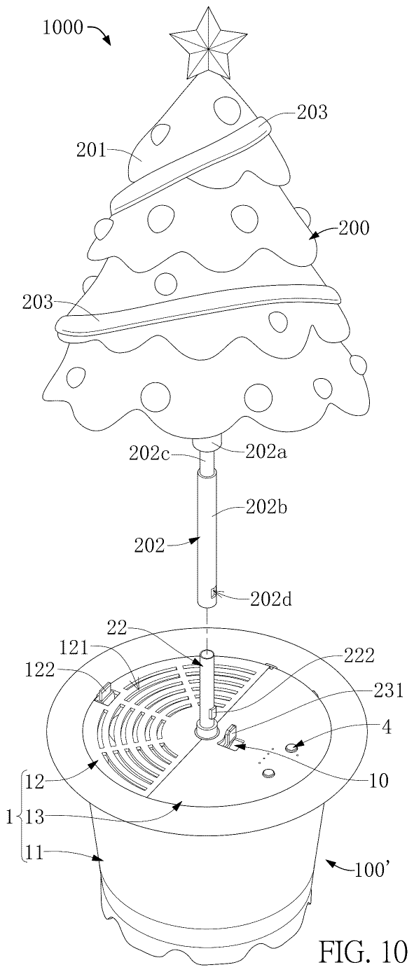

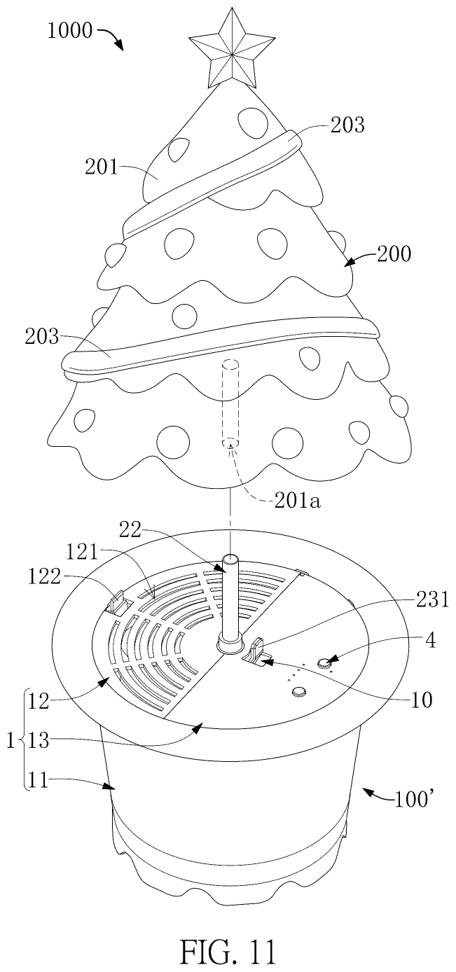

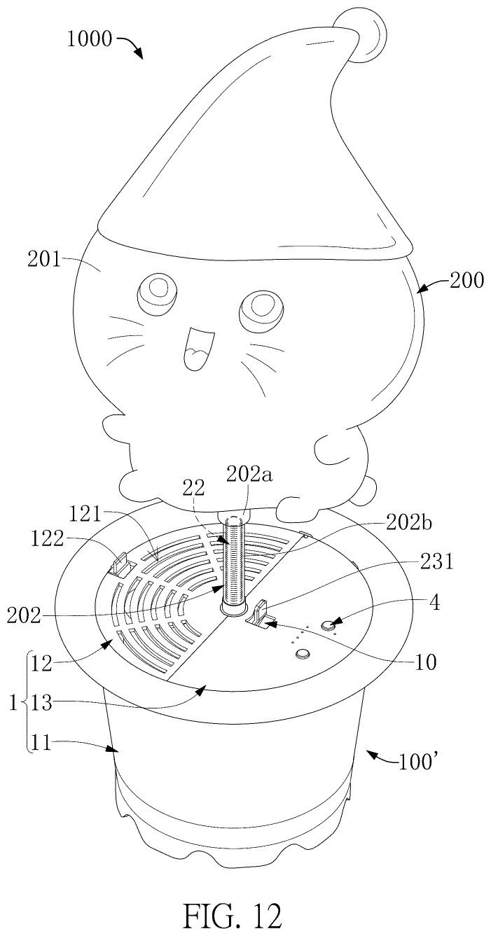

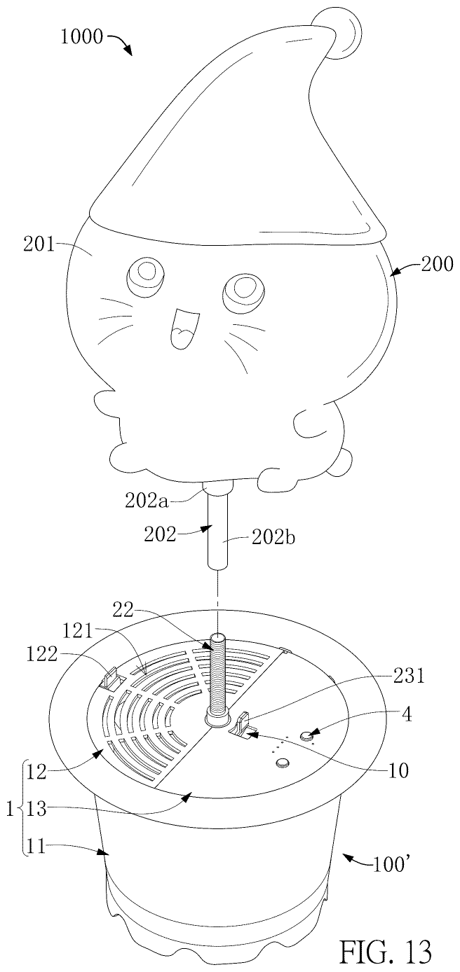

Referring to FIG. 9 and FIG. 13, FIG. 9 is a schematic perspective view of a decoration according to a second embodiment of the present disclosure, FIG. 10 is a schematic exploded view of FIG. 9, FIG. 11 is a schematic perspective view of another type of the decoration of FIG. 9, FIG. 12 is a schematic perspective view of another type of a decorative structure of FIG. 9, and FIG. 13 is a schematic exploded view of FIG. 12.

The present embodiment provides a decoration 1000, which is configured to beautify an indoor environment or an outdoor environment to effectively enhance an overall aesthetic of an environment. The decoration 1000 includes a multifunctional support mechanism 100′ and a decorative structure 200 assembled on the multifunctional support mechanism 100′.

It should be noted that the multifunctional support mechanism 100′ is substantially identical to the aforementioned multifunctional support mechanism 100 of the first embodiment. Accordingly, similarities between the present embodiment and the first embodiment will not be described in detail herein, and differences between the present embodiment and the first embodiment are described as follows:

In the present embodiment, as shown in FIG. 9 and FIG. 10, the decorative structure 200 includes a decorative body 201 and a docking member 202 disposed on one side of the decorative body 201, and the decorative structure 200 is detachably disposed on the connecting member 22 through the docking member 202. Specifically, the decorative body 201 can be selected from an evergreen plant (as shown in FIG. 9 to FIG. 11), a doll (as shown in FIG. 12 and FIG. 13), or a potted plant, etc., and the present disclosure is not limited thereto.

As shown in FIG. 9 and FIG. 10, the docking member 202 includes first connecting portion 202a connected to the decorative body 201, a second connecting portion 202b disposed on one side of the first connecting portion 202a, and an adjusting potion 202c connected to the second connecting portion 202b. However, the docking member 202 can be selectively provided with the adjusting potion 202c according to practical requirements, and the present disclosure is not limited thereto.

Specifically, the first connecting portion 202a is movable in a direction away from the second connecting portion 202b along the adjusting potion 202c to enable the decorative body 201 to move in a direction away from the multifunctional support mechanism 100′. In other words, a height of the decorative structure 200 relative to the multifunctional support mechanism 100′ can be adjusted through the adjusting potion 202c.

Moreover, the second connecting portion 202b is detachably disposed on the connecting member 22. Specifically, the second connecting portion 202b can be a housing that corresponds in shape to the connecting member 22, so as to be sleeved on the connecting member 22.

Furthermore, as shown in FIG. 9 and FIG. 10, one side of the connecting member 22 has a buckle 222 formed thereon. Moreover, the docking member 202 further has a docking portion 202d disposed on the second connecting portion 202b, and the docking potion 202d is a through hole that corresponds in shape to the buckle 222 to be sleeved on the buckle 22. Accordingly, the docking potion 202d and the buckle 222 can be engaged with each other to enable the decorative structure 200 to fix to the multifunctional support mechanism 100′.

However, the aforementioned description illustrates a fixing relationship of the connecting member 22 and the docking member 202 by a configuration between the buckle 222 and the docking portion 222d, but the present disclosure is not limited thereto.

For example, as shown in FIG. 12 and FIG. 13, the connecting member 22 can be provided without the buckle 222, the docking member 202 can be provided without the docking portion 202d, the connecting member 22 has an external thread, and the second connecting portion 202b of the docking member 202 has an internal thread that can be threadedly engaged with the external thread, so as to enable the connecting member 22 and the docking member 202 to fix with each other.

It is worth mentioning that, in the present embodiment, the decorative structure 200 further includes a plurality of light strips 203 disposed on the decorative body 201, but the light strips 203 can be selectively added according to practical requirements, and the present disclosure is not limited thereto. Specifically, the light strips 203 are configured to emit light. Based on the above, referring to FIG. 2, FIG. 7, and FIG. 9 to FIG. 11, when the mist generated by the atomizing sheet 337 is discharged to the external environment, the decorative structure 200 can generate different light effects by a cooperation of the mist generated by the atomizing sheet 337 and the light emitted by the light strips 203.

Specifically, the light strips 203 can be connected to an external connector (not shown in figures) to operate, but the present disclosure is not limited thereto.

In addition, in the present embodiment, a connection relationship of the decorative structure 200 and the multifunctional support mechanism 100′ is described by a configuration between the docking member 202 and the connecting member 22, but the present disclosure is not limited thereto. For example, as shown in FIG. 11, the decorative structure 200 can be provided without the docking member 202, and the decorative body 201 has a docking slot 201a formed therein, and docking slot 201a is corresponds in size to the connecting member 22, so that the decorative structure 200 can be sleeved on the multifunctional support mechanism 100′ through the docking slot 201a.

### Third Embodiment

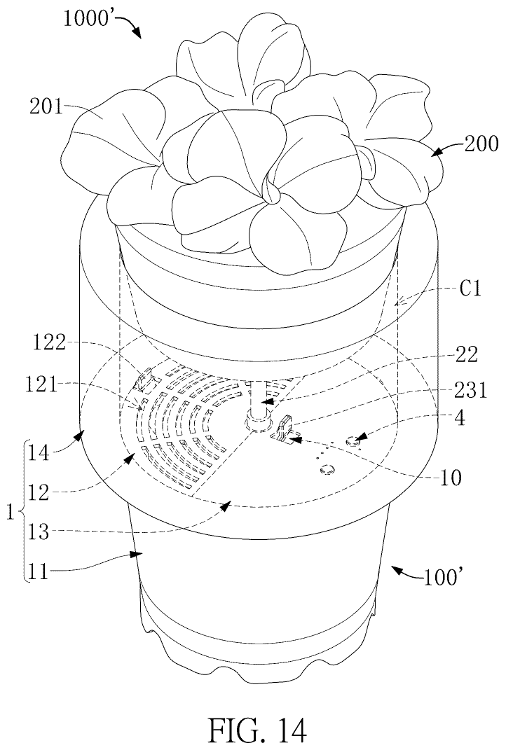

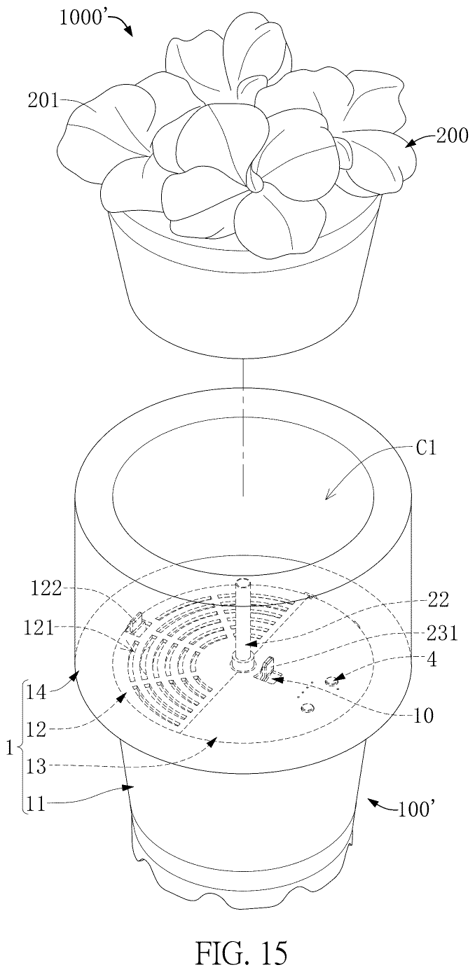

Referring to FIG. 14 and FIG. 15, FIG. 14 is a schematic perspective view of a decoration according to a third embodiment of the present disclosure, and FIG. 15 is a schematic exploded view of FIG. 14.

The present embodiment provides a decoration 1000′, which includes the multifunctional support mechanism 100′ and the decorative structure 200 assembled on the multifunctional support mechanism 100′. It should be noted that the decoration 1000′ is substantially identical to the aforementioned decoration 1000 of the second embodiment. Accordingly, similarities between the present embodiment and the second embodiment will not be described in detail herein, and differences between the present embodiment and the second embodiment are described as follows:

In the present embodiment, the decorative structure 200 is provided without the docking member 202, and the decorative body 201 is illustrated by a potted plant as an example.

As shown in FIG. 14 and FIG. 15, the carrying assembly 1 includes the carrier member 11, the first shielding member 12, the second shielding member 13, and an extension member 14, and the extension member 14 is formed by extending from the carrier member 11 in a direction away from the first shielding member 12 and the second shielding member 13. Moreover, the extension member 14, the first shielding member 12, and the second shielding member 13 jointly define an accommodating cavity C1.

Specifically, the decorative structure 200 is disposed on the extension member 14, and one part of the decorative structure 200 is arranged in the accommodating cavity C1. In other words, the decorative body 201 abuts against the extension member 14 to arrange in the accommodating cavity C1.

In addition, when the one part of the decorative structure 200 is arranged in the accommodating cavity C1, the decorative body 201 abuts against the connecting member 22, and the connecting member 22 can be configured to support the decorative structure 200, but the present disclosure is not limited thereto.

Based on the above, the multifunctional support mechanism 100′ can enable the decorative structure 200 to directly dispose on the carrying assembly 1 through a design of the extension member 14.

### Beneficial Effects of the Embodiment

In conclusion, in the decoration provided by the present disclosure, through a configuration between the decorative structure and the multifunctional support mechanism, an overall aesthetic of an environment (e.g., an indoor environment or an outdoor environment) can be effectively enhanced. Moreover, the fixing assembly, the atomization assembly, and the control member are disposed in the carrier cavity, the external component is connected to the fixing assembly, the atomization assembly atomizes a corresponding liquid to form the mist and discharges the mist to the external environment, and the control member controls the operation of the atomization assembly, so that not only can the external component of various types be replaced, but an atomization effect can also be generated by the atomization assembly. Accordingly, the multifunctional support mechanism not only provides a supporting function, but also has an atomization function.

In addition, the decoration can generate different light effects by a cooperation of the mist generated by the atomizer and the light emitted by the light strips.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A decoration (1000) comprising:
a multifunctional support mechanism (100′) including:
a carrying assembly (1) having a carrier cavity (10);
a fixing assembly (2) disposed in the carrier cavity (10), a fixing end of the fixing assembly (2) being in spatial communication with an external environment, wherein the fixing assembly (2) includes a fixing member (21), a connecting member (22), and an engaging member (23), the fixing member (21) is disposed in the carrier cavity (10), the connecting member (22) is movably disposed in the fixing member (21), the engaging member (23) is rotatably connected to the fixing member (21), and the engaging member (23) abuts against the connecting member (22);
an atomization assembly (3) disposed in the carrier cavity (10), an atomization end of the atomization assembly (3) being in spatial communication with the external environment; and
a control member (4) disposed in the carrier cavity (10), the control member (4) being electrically connected to the atomization assembly (3); and
a decorative structure (200) sleeved on the connecting member (22).

2. The decoration (1000) according to claim 1, wherein the carrying assembly (1) includes a carrier member (11), a first shielding member (12), and a second shielding member (13), the first shielding member (12) and the second shielding member (13) are detachably disposed in the carrier member (11), and the carrier cavity (10) is jointly formed by the carrier member (11), the first shielding member (12), and the second shielding member (13).

3. The decoration (1000) according to claim 2, wherein the carrier member (11) has a carrier slot (111), a first carrier flange (112), and a plurality of first limiting blocks (113), the first carrier flange (112) is disposed around an inner wall of the carrier slot (111), the plurality of first limiting blocks (113) are spaced apart from each other and disposed around the inner wall of the carrier slot (111), a gap is defined between the first carrier flange (112) and the plurality of first limiting blocks (113), the first shielding member (12) and the second shielding member (13) are located in the gap (114), and the carrier cavity is jointly formed by the carrier slot (111), the first shielding member (12), and the second shielding member (13).

4. The decoration (1000) according to claim 3, wherein the first shielding member (12) has a through hole (121) and a buckle (122), the atomization end of the atomization assembly (3) is in spatial communication with the through hole (121), and the buckle (122) movably abuts against the plurality of first limiting blocks (113).

5. The decoration (1000) according to claim 1, wherein the fixing member (21) has an installation slot (211) and a buckling notch (212) that is in spatial communication with the installation slot (211), the connecting member (22) is movably disposed in the installation slot (211), and the engaging member

(23) abuts against a retaining groove (221) of the connecting member (22) through the buckling notch (212).

6. The decoration (1000) according to claim 5, wherein the engaging member (23) includes a pressing plate (231), a cantilever (232) arranged on the pressing plate (231), and a buckling block (233) arranged on the pressing plate (231), the pressing plate (231) is rotatably connected to the fixing member (21) through the cantilever (232), and the buckling block (233) abuts against the retaining groove (221) of the connecting member (22) through the buckling notch (212); wherein the fixing assembly (2) further includes a first elastic member (24), and two ends of the first elastic member (24) are respectively connected to the fixing member (21) and the pressing plate (231).

7. The decoration (1000) according to claim 6, wherein the atomization assembly (3) includes a mounting member (31), a blower (32) disposed in the mounting member (31), and an atomizer (33) disposed in the mounting member (31), the mounting member (31) has a mist outlet (311), an atomization end of the atomizer (33) is in spatial communication with the mist outlet (311), and the atomizer (33) is electrically connected to the control member (4).

8. The decoration (1000) according to claim 7, wherein the atomizer (33) includes a first support tube (331), a support frame (332), a guide tube (333), a second support tube (334), a second elastic member (335), a water-absorbing body (336), an atomizing sheet (337), and a sensor (338); wherein the first support tube (331), the guide tube (333), and the second support tube (334) are in spatial communication with each other, the support frame (332) is disposed in the first support tube (331), the support frame (332) has a first orifice (3321), the second elastic member (335) is disposed in the second support tube (334), the water-absorbing body (336) is connected to the second elastic member (335), the atomizing sheet (337) abuts against the water-absorbing body (336), the atomizing sheet (337) discharges mist outward from the second support tube (334), and a sensing end of the sensor

(338) is located in the first support tube (331), the guide tube (333), or the second support tube (334).

9. The decoration (1000) according to claim 8, wherein the support frame (332) has a top block (3322), the top block (3322) protrudes from the support frame (332), an outer edge of the top block (3322) has a second orifice (3323), and the second orifice (3323) and the first orifice (3321) are in spatial communication with the guide tube (333).

10. The decoration (1000) according to claim 1, wherein the decorative structure (200) includes a decorative body (201) and a docking member (202) disposed on one side of the decorative body (201), and the decorative structure (200) is detachably disposed on the connecting member (22) through the docking member (202).

11. The decoration (1000) according to claim 10, wherein the docking member (202) includes:
a first connecting portion (202a) connected to the decorative body (201);
a second connecting portion (202b) disposed on one side of the first connecting portion (202a) and detachably disposed on the connecting member (22); and
an adjusting potion (202c) connected to the second connecting portion (202b), wherein the first connecting portion (202a) is movable in a direction away from the second connecting portion (202b) along the adjusting potion (202c) to enable the decorative body (201) to move in a direction away from the multifunctional support mechanism (100′).

12. The decoration (1000) according to claim 10, wherein the decorative structure (200) further includes a plurality of light strips (203) disposed on the decorative body (201), and the plurality of light strips (203) are configured to emit light.

13. The decoration (1000) according to claim 11, wherein one side of the connecting member (22) has a buckle (222) formed thereon, the docking member (202) has a docking portion (202d) disposed on the second connecting portion (202b), and the docking portion (202d) corresponds in shape to the buckle (222), and wherein the docking portion (202d) is sleeved on the buckle (222) to enable the decorative structure (200) to fix to the multifunctional support mechanism (100′).

14. The decoration (1000) according to claim 1, wherein the connecting member (22) has an external thread, and the docking member (202) has an internal thread that is threadedly engaged with the external thread.

15. A decoration (1000′) comprising:
a multifunctional support mechanism (100′) including:
a carrying assembly (1) having a carrier cavity (10), wherein the carrying assembly (1) includes a carrier member (11), a first shielding member (12), a second shielding member (13), and an extension member (14), and the extension member (14) is formed by extending from the carrier member (11) in a direction away from the first shielding member (12) and the second shielding member (13), wherein the first shielding member (12) and the second shielding member (13) are detachably disposed in the carrier member (11), and the carrier cavity (10) is jointly formed by the carrier member (11), the first shielding member (12), and the second shielding member (13), and wherein the extension member (14), the first shielding member (12), and the second shielding member (13) jointly define an accommodating cavity (C1);
a fixing assembly (2) disposed in the carrier cavity (10), a fixing end of the fixing assembly (2) being in spatial communication with an external environment, wherein the fixing assembly (2) includes a fixing member (21), a connecting member (22), and an engaging member (23), the fixing member (21) is disposed in the carrier cavity (10), the connecting member (22) is movably disposed in the fixing member (21), the engaging member (23) is rotatably connected to the fixing member (21), and the engaging member (23) abuts against the connecting member (22);
an atomization assembly (3) disposed in the carrier cavity (10), an atomization end of the atomization assembly (3) being in spatial communication with the external environment; and
a control member (4) disposed in the carrier cavity (10), the control member (4) being electrically connected to the atomization assembly (3); and
a decorative structure (200) disposed on the extension member (14), wherein one part of the decorative structure (200) is arranged in the accommodating cavity (C1).
